(19) United States
(12) Patent Application Publication
(10) Pub. No.: US 2012/0042468 A1
(43) Pub. Date: Feb. 23, 2012

(54) Fishing Line Tool

(76) Inventor: David Viles, Dunnville (CA)

(21) Appl. No.: 12/858,061

(22) Filed: Aug. 17, 2010

(51) Int. Cl. A01K 97/00

(52) U.S. Cl. 15/236.01

(57) ABSTRACT

The invention relates generally to a tool for clearing fishing line of water fleas accumulated when fishing in waters containing water fleas and the method of use for this tool. A method for using the fishing line tool is also provided in which a section of fishing line is inserted into the channels of the knife and pulled out to scrape off any fleas which have accumulated on the fishing line.

### FIELD OF THE INVENTION

The invention relates generally to a tool for clearing fishing line of water fleas accumulated when fishing in waters containing water fleas and the method of use for this tool.

### BACKGROUND OF THE INVENTION

The spiny water flea and the fishhook water flea are small crustacean species which have invaded North American waters, for example, Lake Huron, Lake Erie, and Lake Ontario. These fleas are problematic for fishing with fishing line since the fleas can stick to fishing lines. In particular, when fishing line is drawn through waters containing water fleas, the fleas stick to the fishing line and can mat onto the line. Fleas on fishing line may make it difficult or even impossible to spool the line in without stopping to remove the fleas from the line.

Commonly, fishermen use their fingers and/or fingernails to scrape the mats of fleas off of the line as they reel in the line, for instance, at the point of the rod guides or at the end of the fishing swivel. Depending on the amount of fleas and variety, the fleas on the line may turn into a fibrous clot that is very difficult to remove or they may remain as a loose coating that is easily removed with finger tips. In either case, the manual removal of water fleas from fishing line is messy and time consuming.

A fishing line called FLEA-FLICKER™ was developed with a flattened profile monofilament line to prevent accumulation of fleas on it. However, aside from being restricted to using only this brand of line, the some drawbacks of this line are that it is not suitable for several types of controlled depth fishing, it does not spool smoothly, and it also reflects light which can spook fish.

A need for a tool to remove water fleas from any type of fishing line was needed so that fishermen had the flexibility to use their fishing line of choice and remove whatever size of water flea deposit accumulated, easily and effectively.

### SUMMARY OF THE INVENTION

In accordance with one aspect of the invention, there is provided an elongate tool with a handle at one end and a channel at the other end, said channel of a width to enable a section of fishing line to pass through tightly.

In accordance with another aspect of the invention, there is provided a fishing line tool comprising a handle and a blade, said blade including therein a channel slightly wider than the thickness of a fishing line.

In accordance with another aspect of the invention, there is provided a fishing line tool comprising a first grip and a second grip in between which are a first knife, first shim, second knife, second shim, and third knife In this fishing line tool the first shim may be thicker than the second shim, such that the first shim is 0.02 inches thick, the second shim is 0.15 inches thick and the knifes are each 3/16ths of an inch thick.

The fishing line tool additionally comprises a pair of screws and a pair of barrel nuts to hold said fishing line tool together, and said grips, knifes and shims each including two sets of holes positioned so that the screws enter through said first grip and said barrel nuts enter through said second grip.

The grips comprise an outer plate cover and a plate and the outer plate cover is made of one or more of the materials of polyurethane, polymide, nylon and glass fiber, and the knifes and plate are made of aluminum, and the shims, barrel nuts and screws are stainless steel.

In accordance with another aspect of the invention, there is provided a fishing line tool comprising a knife in between a first grip and a second grip, said knife including a channel therein. The fishing line tool additionally comprises two pairs of screws, said screws securing said grips to said knife. The grips comprise an outer plate cover and a plate and the outer plate cover is made of one or more of the components of polyurethane, polymide, nylon and glass fiber, and the knife and plate are made of aluminum, and the screws are made of brass or stainless steel.

In accordance with another aspect of the invention, there is provided a use for a fishing line tool with two channels to remove water fleas from a section of fishing line containing said fleas, comprising the steps of:

a. forming a loop of said section of fishing line containing fleas;
b. sliding said loop into a channel formed between said first knife and second knife; and
c. pulling said loop down and out of said channel.

In accordance with another aspect of the invention, there is provided a use for a fishing line tool with one channel to remove water fleas from a section of fishing line containing said fleas, comprising the steps of:

a. forming a loop of said section of fishing line containing fleas;
b. sliding said loop into the channel in said knife; and
c. pulling said loop down and out of said channel.

### DESCRIPTION OF THE DRAWINGS

In the drawings which illustrate by way of example only two preferred embodiments of the invention:

FIG. 1 is a perspective view of a fishing line tool according to a first embodiment of the invention;

FIG. 2 is an exploded view of the fishing line tool shown in FIG. 1;

FIG. 3 is a perspective view of a fishing line tool according to a second embodiment of the invention;

FIG. 4 is an exploded view of the fishing line tool shown in FIG. 3;

FIG. 5 is perspective view of one segment of the fishing line tool shown in the first and second embodiments of the invention;

FIG. 6 is a perspective view of the first embodiment of the invention and fishing line with a mat of fleas on it;

FIG. 7 is a perspective view of the first embodiment of the invention engaged with the fishing line with a mat of fleas on it;

FIG. 8 is a perspective view of the first embodiment of the invention with the fleas remaining on it and the fishing line cleared of the fleas.

### DETAILED DESCRIPTION OF THE DRAWINGS

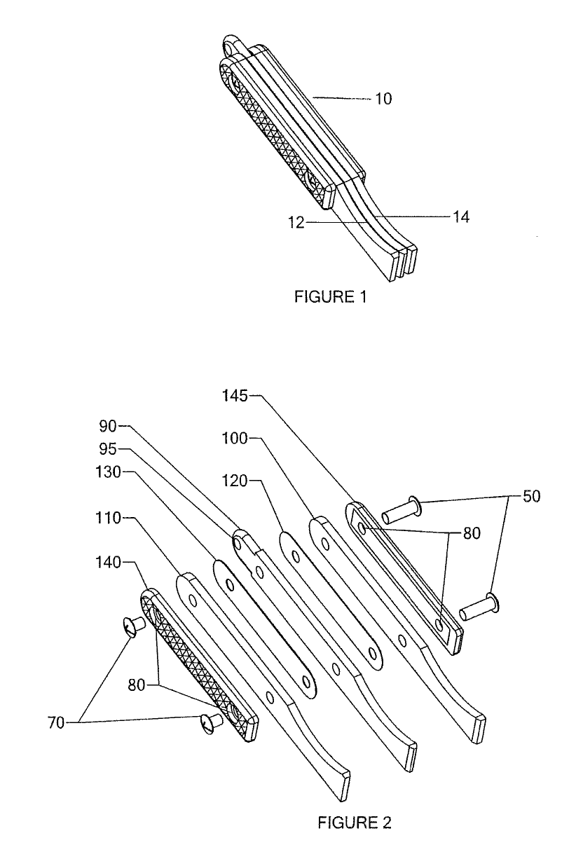

Referring to FIG. 1, a fishing line tool according to a first embodiment of the invention is shown generally at 10 with a first channel 12 and a second channel 14.

Referring to FIG. 2, the fishing line tool according to the first embodiment of the invention is shown in an exploded view in order to see the components of a first grip 140, a second grip 145, in between which there are a first knife 110, a first shim 130, a second knife 90, a second shim 120, a third knife 100. Holes (not numbered) corresponding to the holes 80 in the grips 140 and 145 are found in all the components of the first knife 110, first shim 130, second knife 90, second shim 120 and third knife 100, such that when screws 70 are threaded into the holes 80 in grip 140 and barrel nuts 50 are pushed into holes 80 in grip 145, the components are secured in alignment together.

The thickness of the shims 130 and 120 shown in FIG. 2 determine the size of the channels 12 and 14 shown in FIG. 1. In the embodiment shown in FIGS. 1 and 2, the first shim 130 is thicker than the second shim 120, which results in a larger channel 12 than 14.

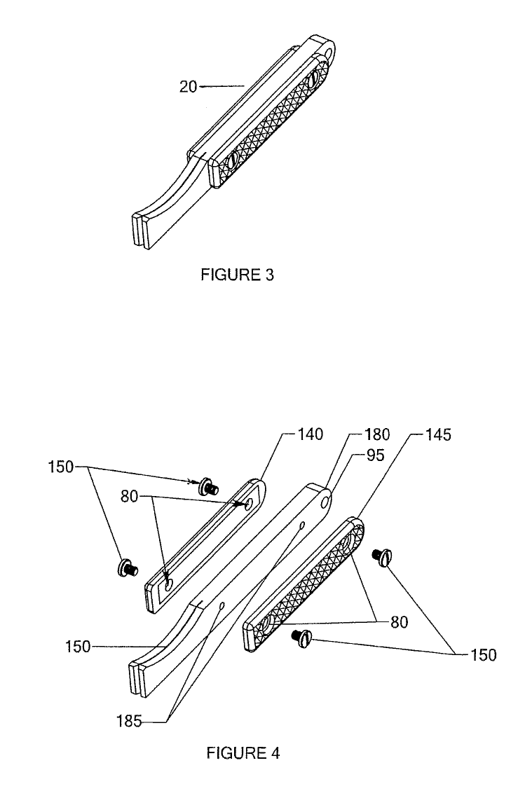

Referring to FIG. 3, a fishing line tool according to a second embodiment of the invention is shown generally at 20.

Referring to FIG. 4, the fishing line tool according to the second embodiment of the invention is shown in exploded view in order to see the components of a first grip 140, a second grip 145, in between which there is a knife 180. The grips 140 and 145 are attached to knife 180 by screws 150 which are screwed into openings 80 in grips 140 and 145, and the screws 150 when fully secured are fastened into either side of knife 180 in corresponding recesses 185. The knife 180 has a channel 150 etched into it. The channel may be carved out of a metal knife 180 by using wire electric discharge machining (“EDM”) technology, with the size of the channel 150 determined by the setting.

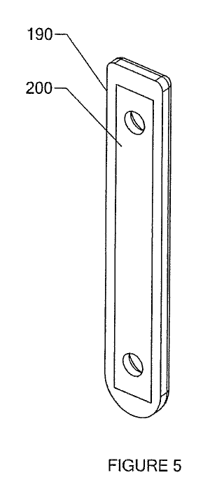

FIG. 5 shows that the grips 140 and 145 in FIGS. 1 through 4 are comprised of two components, a plate cover 190 and a plate 200. The plate cover 190 may be notched to give better grip and coloured for ornamental purposes. The grips 140 and 145 with the components in between them serve to form the handle of the fishing line tool 10 and 20.

In the figures, the second knife 90 and knife 180 are shown extended to provide a hole 95 which makes it easier to access or store the fishing line tool, for example, the hole 95 may be used to enable the fishing line tool to be hung up or put on a keychain or a lanyard to fasten to, for example, a wrist for ease of accessibility during periods of repeated use0

In the first and second embodiments of the invention shown in the figures the components may be made of the following materials: the knifes 180, 110, 90 and 100 and plate 200 of aluminum; the plate cover 190 of polyurethane or injected-molded polymide-nylon with 15% glass fiber reinforcement; the shims 130 and 120 and barrel nuts 50 of stainless steel; the screws 70 and 150 of stainless steel or brass.

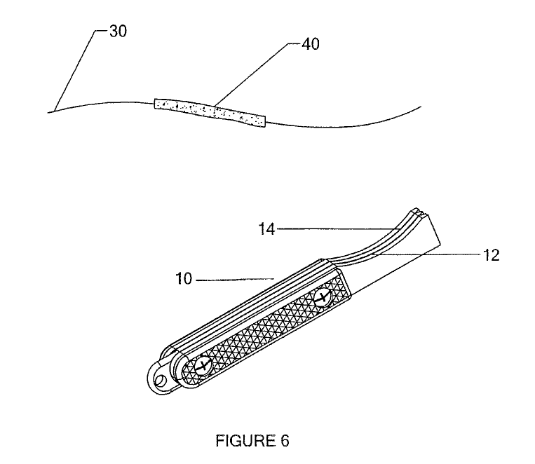

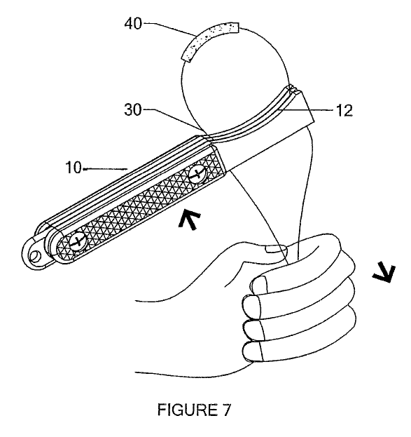

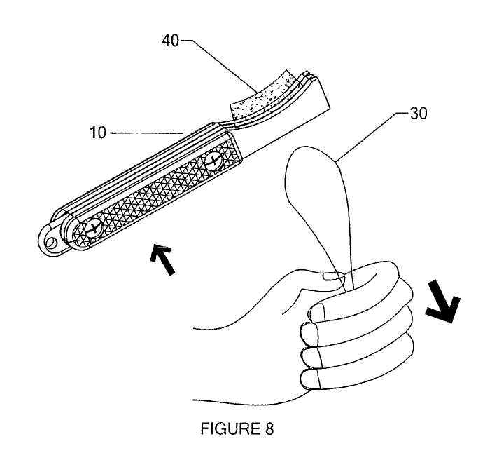

FIGS. 6 through 8 demonstrate the use of the fishing line tool of the present invention and in this demonstration the first embodiment of the fishing line tool 10 is shown. Referring to FIG. 6, fishing line tool 10 is shown alongside a portion of fishing line 30 with a mat of fleas 40. In FIG. 7, a loop of fishing line 30 has been inserted sideways into channel 12 such that the mat of fleas 40 is above the fishing line tool 10. In FIG. 8, the fishing line 30 has been pulled down out of the fishing line tool 10 and emerged free of the mat of fleas 40 which was scraped off and left on the fishing line tool 10. The fishing line tool 10 can be shaken out on the outside of the boat, or in the water or wiped off to avoid messing up a boat with flea debris.

The fishing line tool 20 is used in the same manner wherein a loop of fishing line with a mat of water fleas would be slid into channel 150 and pulled down through the channel 150 to scrape off the mat of fleas.

The size of the channels 12 and 14 in the first embodiment and channel 150 in the second embodiment is chosen for the size of fishing line that will pass through the channel in order to most effectively clear a mat of fleas off of the line. The channel is slightly wider than the fishing line with which it will be used, which allows a section of fishing line to pass tightly but readily through the channel. For example, in the fishing line tool 10 the first shim could be 0.02 inches thick, the second shim 120 could be 0.015 inches thick and the knifes 110, 90 and 100 could all be 3/16ths of an inch thick, forming channel 12 for use with fishing line of 0.35 mm diameter and channel 14 for fishing line of 0.45 mm diameter.

After repeated used of the fishing line tool of this invention, fishing line may weaken and it may be desirous to cut out the portion of the line that has been weakened from the remaining line.

Various embodiments of the present invention having been thus described in detail by way of example, it will be apparent to those skilled in the art that variations and modifications may be made without departing from the invention. The invention includes all such variations and modifications as fall within the scope of the appended claims.

1. An elongate tool with a handle at one end and a channel at the other end, said channel of a width to enable a section of fishing line to pass through tightly.

2. A fishing line tool comprising a handle and a blade, said blade including therein a channel slightly wider than the thickness of a fishing line.

3. A fishing line tool comprising a first grip and a second grip in between which are a first knife, first shim, second knife, second shim, and third knife.

4. The fishing line tool of claim 3 in which the first shim is thicker than the second shim.

5. The fishing line tool of claim 3 in which the first shim is 0.02 inches thick, the second shim is 0.015 inches thick and the knifes are each 3/16ths of an inch thick.

6. The fishing line tool of claim 3 additionally comprising a pair of screws and a pair of barrel nuts to hold said fishing line tool together, and said grips, knifes and shims each including two sets of holes positioned so that the screws enter through said first grip and said barrel nuts enter through said second grip.

7. The fishing line tool of claim 6 in which said grips comprise an outer plate cover and a plate and the outer plate cover is made of one or more of the materials of polyurethane, polymide, nylon and glass fiber, and the knifes and plate are made of aluminum, and the shims, barrel nuts and screws are stainless steel.

8. A fishing line tool comprising a knife in between a first grip and a second grip, said knife including a channel therein.

9. The fishing line tool of claim 8 which additionally comprises two pairs of screws, said screws securing said grips to said knife.

10. The fishing line tool of claim 9 in which said grips comprise an outer plate cover and a plate and the outer plate cover is made of one or more of the components of polyurethane, polymide, nylon and glass fiber, and the knife and plate are made of aluminum, and the screws are made of brass or stainless steel.

11. The use of the fishing line tool of claim 3 to remove water fleas from a section of fishing line containing said fleas, comprising the steps of:
a. forming a loop of said section of fishing line containing fleas;
b. sliding said loop into a channel formed between said first knife and second knife; and
c. pulling said loop down and out of said channel.

12. The use of the fishing line tool of claim 1 to remove water fleas from a section of fishing line containing said fleas, comprising the steps of:
a. forming a loop of said section of fishing line containing fleas;
b. sliding said loop into the channel in said knife; and
c. pulling said loop down and out of said channel.

13. The use of the fishing line tool of claim 2 to remove water fleas from a section of fishing line containing said fleas, comprising the steps of
a. forming a loop of said section of fishing line containing fleas;
b. sliding said loop into the channel in said knife; and
c. pulling said loop down and out of said channel.

14. The use of the fishing line tool of claim 8 to remove water fleas from a section of fishing line containing said fleas, comprising the steps of:
a. forming a loop of said section of fishing line containing fleas;
b. sliding said loop into the channel in said knife; and
c. pulling said loop down and out of said channel.
